(19) United States
(12) Patent Application Publication
(10) Pub. No.: US 2011/0060865 A1
(43) Pub. Date: Mar. 10, 2011

(54) Systems and Methods for Flash Memory Utilization

(75) Inventors: Robert W. Warren, Loveland, CO (US); David L. Dreifus, Clinton, NJ (US); Robert E. Ober, San Jose, CA (US)

(73) Assignee: LSI Corporation

(21) Appl. No.: 12/772,005

(22) Filed: Apr. 30, 2010

Related U.S. Application Data
(60) Provisional application No. 61/240,465, filed on Sep. 8, 2009.

(51) Int. Cl. G06F 12/02; G06F 12/00

(52) U.S. Cl. 711/103; 711/E12.001; 711/E12.008

(57) ABSTRACT

Various embodiments of the present invention provide systems, methods and circuits for memories and utilization thereof. As one example, a memory system is disclosed that includes a non-volatile memory, a flash memory, and a read/write controller circuit. The read/write controller circuit is coupled to both the flash memory and the non-volatile memory, and is operable to receive a data set directed to the flash memory and to direct the data set to the random access memory.

### CROSS REFERENCE TO RELATED APPLICATIONS

The present application claims priority to (is a non-provisional of) U.S. Pat. App. No. 61/240,465, entitled “Utilization of NVSRAM to Buffer Data Structures for Reducing the Number of Accesses to Flash Memory”, and filed Sep. 8, 2009 by Warren et al. The entirety of the aforementioned provisional patent application is incorporated herein by reference for all purposes.

### BACKGROUND OF THE INVENTION

The present inventions are related to systems and methods for extending flash memory lifecycle, and more particularly to systems and methods for reducing accesses to a flash memory.

Flash memories have been used in a variety of devices where information stored by the device must be maintained even when power is lost to the device. A typical flash memory device exhibits a number of cells that can be charged to four distinct voltage levels representing two bits of data stored to the cell. By doing this, the memory density of a given flash device can be increased dramatically for the cost of a few additional comparators and a reasonable increase in write logic. Currently, there is a trend toward further increasing the number of bits that may be stored in any given cell by increasing the number of distinct voltage levels that may be programmed to the cell. For example, there is a trend toward increasing the number of distinct voltage levels to eight so that each cell can hold three data bits. While the process of increasing the number of bits stored to any given flash memory cell allows for increasing bit densities, it can result in a marked decline in the lifecycle of the flash memory. This decline in the lifecycle of a memory device limits its use in various memory systems where the number of writes is expected to be significant.

Hence, for at least the aforementioned reason, there exists a need in the art for advanced systems and methods for implementing memory systems utilizing flash memory devices.

### BRIEF SUMMARY OF THE INVENTION

The present inventions are related to systems and methods for extending flash memory lifecycle, and more particularly to systems and methods for reducing accesses to a flash memory.

Various embodiments of the present invention provide memory systems that include a random access memory, a flash memory, and a read/write controller circuit. The read/write controller circuit is coupled to both the flash memory and the random access memory, and is operable to receive a data set directed to the flash memory and to direct the data set to the random access memory. By directing the data set to the random access memory, the lifecycle of the flash memory is extended as the number of writes to the flash memory is reduced.

In some instances of the aforementioned embodiments, the read/write controller circuit is further operable to direct a read request for the data set to the random access memory. In such cases, the read/write controller circuit may be further operable to transfer a data block from the random access memory to the flash memory to make room for the data set in the random access memory. In some cases, the data block is selected by the read/write controller circuit using a replacement algorithm that may be, but is not limited to, a least recently used algorithm.

In various instances of the aforementioned embodiments, the memory system further includes a wear leveling circuit that is operable to select a location in the flash memory to receive the data block. The wear leveling circuit implements a wear leveling algorithm that seeks to evenly spread writes across the cells of the flash memory.

In one or more instances, the read/write controller circuit and the random access memory are implemented on the same chip. In some instances, the read/write controller circuit, the random access memory, and the flash memory are combined into a replaceable memory subsystem. In some such instances, the replaceable memory subsystem is a solid state disk drive. In various cases, the flash memory is implemented on a replaceable flash memory unit apart from the read/write controller circuit and the random access memory.

Other embodiments of the present invention provide methods for data storage. Such methods include providing a memory system having a random access memory and a flash memory; receiving a first data set; writing the first data set to the random access memory; receiving a second data set; transferring the first data set to the flash memory; and writing the second data set to the random access memory. In some cases, the methods further include receiving a read request for the second data set; and accessing the second data set from the random access memory. In one or more cases, the methods further include receiving a read request for the first data set; and accessing the first data set from the flash memory. In various cases, the methods further include applying a replacement algorithm to data in the random access memory such that the first data set is selected to be transferred to the flash memory based at least in part on application of the replacement algorithm. In particular cases, the methods further include applying a wear leveling algorithm to determine a location in the flash memory to which the first data set is written. Such a wear leveling algorithm operates evenly spread writes across the cells of the flash memory.

Yet other embodiments of the present invention provide computer systems that include a processor and a memory system accessible to the processor. The memory system includes a random access memory, a flash memory and a read/write controller circuit. The read/write controller circuit is coupled to both the flash memory and the random access memory, and is operable to receive a data set directed to the flash memory and to direct the data set to the random access memory such that the lifecycle of the flash memory is extended.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a computer system including both non-volatile RAM and flash memory in accordance with one or more embodiments of the present invention;

FIG. 2 shows another computer system including both non-volatile RAM and flash memory utilizing a controller with a wear leveling circuit in accordance with some embodiments of the present invention;

FIG. 3 shows yet another computer system including both non-volatile RAM and flash memory utilizing a controller with an incremental flash memory selector in accordance with various embodiments of the present invention;

FIG. 4 shows yet another computer system including both non-volatile RAM and flash memory utilizing a controller without wear leveling control in accordance with some embodiments of the present invention;

FIG. 5 shows yet another computer system including both non-volatile RAM and flash memory including replaceable flash memory units in accordance with some embodiments of the present invention;

FIG. 6 depicts yet another computer system including both non-volatile RAM and flash memory including replaceable solid state drives and an alternative non-volatile memory unit in accordance with one or more embodiments of the present invention;

FIG. 7 is a flow diagram showing a method in accordance with various embodiments of the present invention for utilizing a combination memory system including both non-volatile RAM and flash memory;

FIG. 8 is a flow diagram showing a method in accordance with some embodiments of the present invention for replacing flash memory units; and

FIG. 9 is a flow diagram showing a method in accordance with some embodiments of the present invention for performing a memory system shutdown.

### DETAILED DESCRIPTION OF THE INVENTION

The present inventions are related to systems and methods for extending flash memory lifecycle, and more particularly to systems and methods for reducing accesses to a flash memory.

Accessing a storage area associated with a storage medium in a memory device or computer system may involve accessing certain data more than other data. This is problematic where the memory system is implemented using flash memory devices as memory cells within the flash memory devices have a finite lifecycle that corresponds to the number of times a given memory cell is accessed. As used herein, the term “lifecycle” is used in its broadest sense to mean any combination of ability to reliably write and read back and/or ability to retain stored information over extended time periods. To extend the overall life of a flash memory device, a wear leveling circuits may be employed to distribute accesses across memory cells in a flash memory device or flash memory system. Such wear leveling generally operates to assure that memory cells degrade at approximately the same rate and reach the end of their lifecycle at about the same time. Because of the attempt to force similar degradation across cells in the flash memory, writing a data set can result in moving one or more other data sets within the flash memory. Thus, a read/modify/write command may result in writing data back to the flash memory device at a different location than that from which it was read. In addition, non-accessed data may need to be moved to another location to make room for the data being written back. Thus, rather than a single write, a write back may involve two or more data writes to assure that degradation to the flash memory cells is leveled.

In some cases, a table may be maintained to track the logical location of a data set written to the flash memory. This table may be accessed the next time that the data set is to be accessed to resolve a virtual address to a logical location on the flash memory. Such a table may be written to the flash memory quite often resulting in considerable wear to the data cells to which it is written. Where the wear leveling algorithm is applied to writes of the table, the wear is distributed across a large number of data cells resulting in considerable wear to the flash memory device.

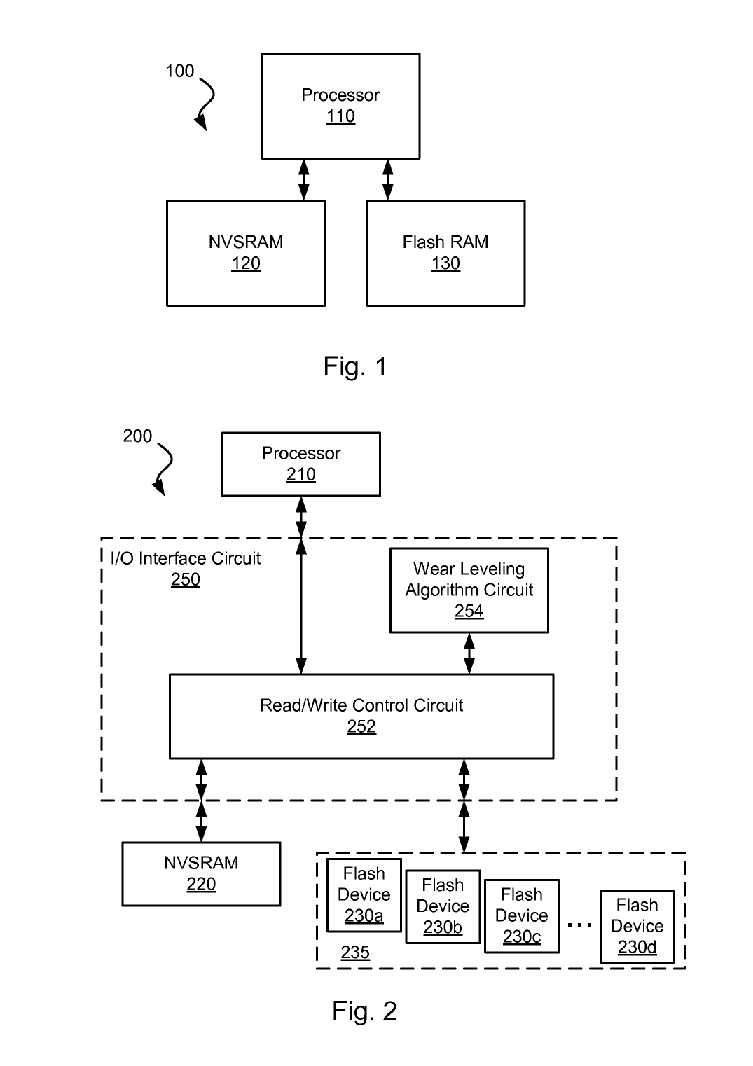

Various embodiments of the present invention utilize a non-volatile memory to limit the number of writes to a flash memory. Turning to FIG. 1, a computer system 100 is depicted including both non-volatile static random access memory (NVSRAM) 120 and flash random access memory (RAM) 130 in accordance with one or more embodiments of the present invention. NVSRAM 120 may be any NVSRAM known in the art, or may be replaced with another type of non-volatile memory. Flash memory 130 may be any type of flash memory known in the art including, but not limited to, single bit per cell flash memory, two bit per cell flash memory, three bit per cell flash memory, flash memory with a built in wear leveling circuitry, flash memory without any wear leveling circuitry, or the like. In some cases, flash memory 130 is composed of many individual flash memory devices. In some such cases, flash memory 130 includes a controller circuit governing access to the various flash memory devices. Processor 110 may be any processor known in the art, and the connections between processor 110 and NVSRAM 120 and flash memory 130 may be either direct, or via an interface chip such as, for example, a south bridge circuit as is commonly known in the art. In some cases, NVSRAM 120 is smaller (i.e., holds less data) than flash memory 130. In one particular case, flash memory 130 is ten times larger than NVSRAM 120. Based upon the disclosure provided herein, one of ordinary skill in the art will recognize a variety of sizes for flash memory 130 and NVSRAM 120, and ratios between the sizes of flash memory 130 and NVSRAM 120.

In operation, any memory read request from processor 110 is satisfied from NVSRAM 120 if possible, and from flash memory 130 if the read request cannot be satisfied from NVSRAM 120. Where a data set associated with the request is modified, the modified data set is written back to NVSRAM 120. Where NVSRAM 120 is full, the write back to NVSRAM 120 may require a write back of a block of data from NVSRAM 120 to flash memory 130 to make room for the newly modified data. The replacement scheme used to select the block of data to be transferred from NVSRAM 120 to flash memory 130 may be, for example, a least recently used replacement scheme. Based upon the disclosure provided herein, one of ordinary skill in the art may recognize other replacement schemes that may be used. In some cases, where the table that tracks the logical location of data sets is accessed often, the replacement scheme maintains the table in NVSRAM 120. As such, substantial degradation to the flash memory devices may be limited.

As a more particular example of operation, where a read/modify/write command is executed, NVSRAM 120 is accessed to determine whether it holds the data set indicated by the read/write/modify command. Where the data set is available in NVSRAM 120, it is read without accessing flash memory 130. Once modified, the data set is written back to NVSRAM 120 without accessing flash memory 130. Only when NVSRAM 120 is full and the data set is selected as part of a block to be unloaded from NVSRAM 120 (or where applicable when a power down occurs) is the data set written back to flash memory 130. Alternatively, where the data set indicated by the read/write/modify command is not available in NVSRAM 120, flash memory 130 is accessed to obtain the data set. Once the modification is complete, the data is written back to NVSRAM 120. Again, this write back may include a block transfer from NVSRAM 120 to flash memory 130 to make room for the newly modified data. Utilizing NVSRAM 120 limits the number of write accesses that are performed to flash memory 130 resulting in extended lifecycle of the flash memory devices

As another example, where a read command is executed, NVSRAM 120 is accessed to determine whether it holds the data set indicated by the read command. Where the data set is available in NVSRAM 120, it is read without accessing flash memory 130. Alternatively, where the data set indicated by the read command is not available in NVSRAM 120, flash memory 130 is accessed to obtain the data set. Of note, the data set is maintained wherever it was in either NVSRAM 120 or flash memory 130. In this case, flash memory 130 is not necessarily avoided. Allowing access into the flash memory is less of a problem as the degradation caused by reading a flash memory cell is less than that caused by a write to a flash memory cell.

As yet another example, where a write command is executed, the data set indicated by the write command is written to NVSRAM 120 without accessing flash memory 130. Only when NVSRAM 120 is full and the data set is selected as part of a block to be unloaded from NVSRAM 120 (or where applicable when a power down occurs) is the data set written to flash memory 130. The write to NVSRAM 120 may include a block transfer from NVSRAM 120 to flash memory 130 to make room for the newly written data. Utilizing NVSRAM 120 again limits the number of write accesses that are performed to flash memory 130 resulting in extended lifecycle of the flash memory devices.

In addition, any state of a memory controller governing operation of flash memory 130 may be maintained in NVSRAM 120. In particular, NVSRAM 120 may store all pertinent code and data through a power off sequence where NVSRAM 120 has an ability to maintain the stored data through a power down period. When power is reapplied to the memory system (i.e., the combination of NVSRAM 120 and flash memory 130) of computer system 100, the various startup codes and information can be accessed from NVSRAM 120 in a relatively short period of time. By doing this, startup time for the memory may be substantially reduced. As an example, it is common for the startup time of a flash memory based memory device to take between one half (0.5) and two (2.0) seconds. In contrast, accessing NVSRAM 120 is much faster resulting in a reduction of the period required to restart a system.

Turning to FIG. 2, a computer system 200 is shown that includes a processor 210 that is communicably coupled to a memory system having both an NVSRAM 220 and a flash memory 235 utilizing an interface circuit 250 having a wear leveling algorithm circuit 254 and a read/write control circuit 252 in accordance with some embodiments of the present invention. NVSRAM 220 may be any NVSRAM known in the art, or may be replaced with another type of non-volatile memory. Flash memory 235 may be any type of flash memory known in the art including, but not limited to, single bit per cell flash memory, two bit per cell flash memory, three bit per cell flash memory, flash memory with a built in wear leveling circuitry, flash memory without any wear leveling circuitry, or the like. Flash memory 235 is composed of many individual flash memory devices 230. In some cases, flash memory 235 includes a controller circuit (not shown) that is included as part of flash memory 235 and governs access to flash memory devices 230. It should be noted that while flash memory 235 is shown as including four flash memory devices 230, that other numbers of flash memory devices may be used to comprise a flash memory in accordance with different embodiments of the present invention. Processor 210 may be any processor known in the art, and the connections between processor 210 and I/O interface circuit 250 may be either direct, or via another interface circuit. In some cases, NVSRAM 220 is smaller (i.e., holds less data) than flash memory 235. In one particular case, flash memory 235 is ten times larger than NVSRAM 220. Based upon the disclosure provided herein, one of ordinary skill in the art will recognize a variety of sizes for flash memory 235 and NVSRAM 220, and ratios between the sizes of flash memory 235 and NVSRAM 220.

In operation, any memory read request from processor 210 is directed by read/write control circuit 252 to be satisfied from NVSRAM 220 if possible, and from flash memory 235 if the read request cannot be satisfied from NVSRAM 220. Where a data set associated with the request is modified, read/write control circuit 252 directs writing of the modified data set to NVSRAM 220. Where NVSRAM 220 is full, read/write control circuit 252 causes a block transfer from NVSRAM 220 to flash memory 235 to make room for the newly modified data. The size of the block transfer may be the size of blocks expected by flash memory 235. The physical locations in flash memory 235 to which the block of transferred data will be written are selected by wear leveling algorithm circuit 254. Wear leveling algorithm circuit 254 seeks to assure that degradation of each of the cells within flash memory 235 remains approximately the same. As such, wear leveling algorithm circuit 254 may implement any flash memory wear leveling algorithm known in the art. The block transfer from NVSRAM 220 to flash memory 235 includes data selected based upon a replacement scheme implemented by read/write control circuit 252. This replacement scheme may be, for example, a least recently used replacement scheme. Based upon the disclosure provided herein, one of ordinary skill in the art may recognize other replacement schemes that may be used. In some cases, where the table that tracks the logical location of data sets is accessed often, the replacement scheme maintains the table in NVSRAM 220. As such, substantial degradation to the flash memory 235 may be limited.

As a more particular example of operation, where a read/modify/write command is executed by processor 210, NVSRAM 220 is accessed under the control of read/write control circuit 252 to determine whether it holds the data set indicated by the read/write/modify command. Where the data set is available in NVSRAM 220, it is read without accessing flash memory 235. Once modified by processor 210, the data set is written back to NVSRAM 220 by read/write control circuit 252 without accessing flash memory 235. Only when NVSRAM 220 is full and the data set is selected as part of a block to be unloaded from NVSRAM 220 (or where applicable when a power down occurs) is the data set written back to flash memory 235. The block of data selected for transfer from NVSRAM 220 to flash memory 235 is selected based upon a replacement algorithm implemented by read/write control circuit 252. Further, the location to which the block of transferred data will be written in flash memory 235 are selected by wear leveling algorithm circuit 254. Alternatively, where the data set indicated by the read/write/modify command is not available in NVSRAM 220, flash memory 235 is accessed to obtain the data set. Once the modification is completed by processor 210, the data set is written back to NVSRAM 220. Again, this write back may include a block transfer from NVSRAM 220 to flash memory 235 under control of read/write control circuit 252 to make room for the newly modified data. Utilizing NVSRAM 220 limits the number of write accesses that are performed to flash memory 235 resulting in extended lifecycle of the flash memory 235.

As another example, where a read command is executed by processor 210, NVSRAM 220 is accessed by read/write control circuit 252 to determine whether it holds the data set indicated by the read command. Where the data set is available in NVSRAM 220, it is read without accessing flash memory 235. Alternatively, where the data set indicated by the read command is not available in NVSRAM 220, flash memory 235 is accessed by read/write control circuit 252 to obtain the data set. Of note, the data set is maintained wherever it was in either NVSRAM 220 or flash memory 235. In this case, flash memory 235 is not necessarily avoided. Allowing access into the flash memory is less of a problem as the degradation caused by reading a flash memory cell is less than that caused by a write to a flash memory cell.

As yet another example, where a write command is executed by processor 210, the data set indicated by the write command is written to NVSRAM 220 by read/write control circuit 252 without accessing flash memory 235. Only when NVSRAM 220 is full and the data set is selected as part of a block to be unloaded from NVSRAM 220 (or where applicable when a power down occurs) is the data set written to flash memory 235. The write to NVSRAM 220 may include a block transfer from NVSRAM 220 to flash memory 235 to make room for the newly written data. The block of data selected for transfer from NVSRAM 220 to flash memory 235 is selected based upon a replacement algorithm implemented by read/write control circuit 252. Further, the location to which the block of transferred data will be written in flash memory 235 are selected by wear leveling algorithm circuit 254. Utilizing NVSRAM 220 again limits the number of write accesses that are performed to flash memory 235 resulting in extended lifecycle of the flash memory devices.

In addition, any state of a memory controller governing operation of flash memory 235 may be maintained in NVSRAM 220. In particular, NVSRAM 220 may store all pertinent code and data through a power off sequence where NVSRAM 220 has an ability to maintain the stored data through a power down period. When power is reapplied to the memory system (i.e., the combination of NVSRAM 220 and flash memory 235) of computer system 200, the various startup codes and information can be accessed from NVSRAM 220 in a relatively short period of time. By doing this, startup time for the memory may be substantially reduced. As an example, it is common for the startup time of a flash memory based memory device to take between one half (0.5) and two (2.0) seconds. In contrast, accessing NVSRAM 220 is much faster resulting in a reduction of the period required to restart a system.

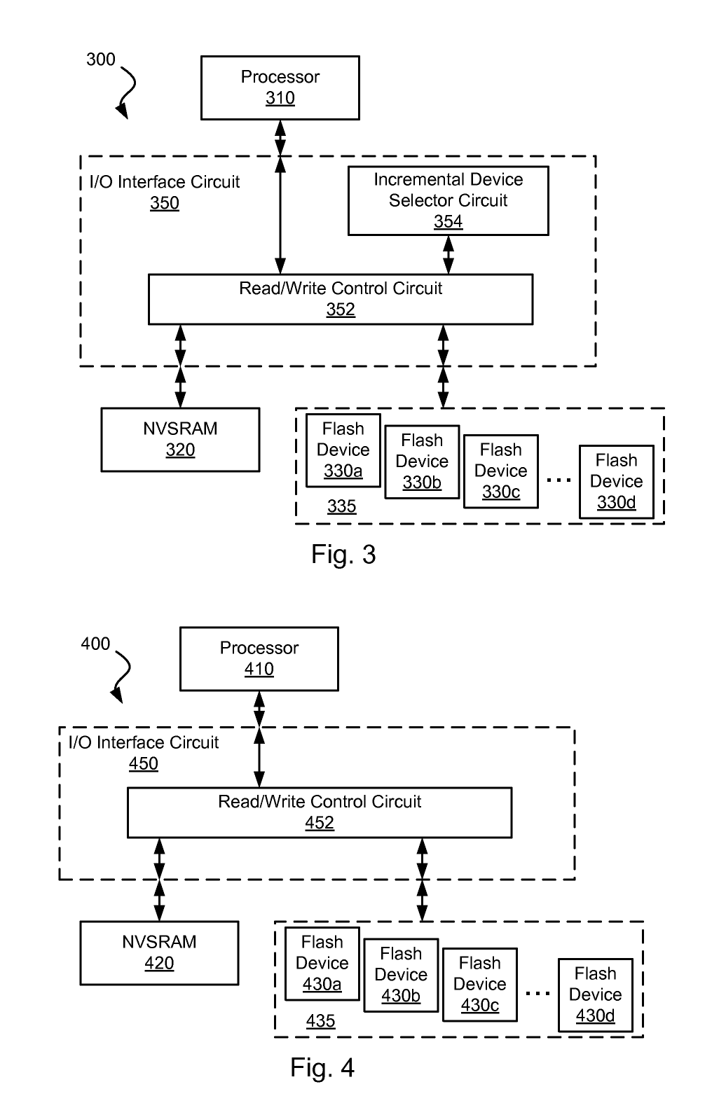

Turning to FIG. 3, a computer system 300 is shown that includes a processor 310 that is communicably coupled to a memory system having both an NVSRAM 320 and a flash memory 335 utilizing an interface circuit 350 having an incremental device selector circuit 354 and a read/write control circuit 352 in accordance with some embodiments of the present invention. NVSRAM 320 may be any NVSRAM known in the art, or may be replaced with another type of non-volatile memory. Flash memory 335 may be any type of flash memory known in the art including, but not limited to, single bit per cell flash memory, two bit per cell flash memory, three bit per cell flash memory, flash memory with a built in wear leveling circuitry, flash memory without any wear leveling circuitry, or the like. Flash memory 335 is composed of many individual flash memory devices 330. It should be noted that while flash memory 335 is shown as including four flash memory devices 330, that other numbers of flash memory devices may be used to comprise a flash memory in accordance with different embodiments of the present invention. Processor 310 may be any processor known in the art, and the connections between processor 310 and I/O interface circuit 350 may be either direct, or via another interface circuit. In some cases, NVSRAM 320 is smaller (i.e., holds less data) than flash memory 335. In one particular case, flash memory 335 is ten times larger than NVSRAM 320. Based upon the disclosure provided herein, one of ordinary skill in the art will recognize a variety of sizes for flash memory 335 and NVSRAM 320, and ratios between the sizes of flash memory 335 and NVSRAM 320.

In operation, any memory read request from processor 310 is directed by read/write control circuit 352 to be satisfied from NVSRAM 320 if possible, and from flash memory 335 if the read request cannot be satisfied from NVSRAM 320. Where a data set associated with the request is modified, read/write control circuit 352 directs writing of the modified data set to NVSRAM 320. Where NVSRAM 320 is full, read/write control circuit 352 causes a block transfer from NVSRAM 320 to flash memory 335 to make room for the newly modified data. The size of the block transfer may be the size of blocks expected by flash memory 335. The particular flash memory device 330 within flash memory 335 to which the block of transferred data will be written is selected by incremental device selector circuit 354. Incremental device selector circuit 354 performs a rudimentary wear leveling algorithm that seeks to assure that degradation of each of the cells within flash memory 335 remains approximately the same. Such wear leveling is less complicated that typical wear leveling algorithms known in the art, but seeks to assure some degree of wear leveling by incrementally selecting flash memory devices 330. Thus, for example, one write may be directed to flash memory device 330a. A subsequent write is directed to flash memory device 330b. The next write is written to flash memory device 330c followed by a write to flash memory device 330d. A write following a write to flash memory device 330d is directed by incremental device selector circuit 354 to flash memory device 330a. The block transfer from NVSRAM 320 to flash memory 335 includes data selected based upon a replacement scheme implemented by read/write control circuit 352. This replacement scheme may be, for example, a least recently used replacement scheme. Based upon the disclosure provided herein, one of ordinary skill in the art may recognize other replacement schemes that may be used. In some cases, where the table that tracks the logical location of data sets is accessed often, the replacement scheme maintains the table in NVSRAM 320. As such, substantial degradation to the flash memory 335 may be limited.

As a more particular example of operation, where a read/modify/write command is executed by processor 310, NVSRAM 320 is accessed under the control of read/write control circuit 352 to determine whether it holds the data set indicated by the read/write/modify command. Where the data set is available in NVSRAM 320, it is read without accessing flash memory 335. Once modified by processor 310, the data set is written back to NVSRAM 320 by read/write control circuit 352 without accessing flash memory 335. Only when NVSRAM 320 is full and the data set is selected as part of a block to be unloaded from NVSRAM 320 (or where applicable when a power down occurs) is the data set written back to flash memory 335. The block of data selected for transfer from NVSRAM 320 to flash memory 335 is selected based upon a replacement algorithm implemented by read/write control circuit 352. Further, the flash memory device 330 to which the block of transferred data will be written in flash memory 335 is selected by incremental device selector circuit 354. Alternatively, where the data set indicated by the read/write/modify command is not available in NVSRAM 320, flash memory 335 is accessed to obtain the data set. Once the modification is completed by processor 310, the data set is written back to NVSRAM 320. Again, this write back may include a block transfer from NVSRAM 320 to flash memory 335 under control of read/write control circuit 352 to make room for the newly modified data. Utilizing NVSRAM 320 limits the number of write accesses that are performed to flash memory 335 resulting in extended lifecycle of flash memory 335.

As another example, where a read command is executed by processor 310, NVSRAM 320 is accessed by read/write control circuit 352 to determine whether it holds the data set indicated by the read command. Where the data set is available in NVSRAM 320, it is read without accessing flash memory 335. Alternatively, where the data set indicated by the read command is not available in NVSRAM 320, flash memory 335 is accessed by read/write control circuit 352 to obtain the data set. Of note, the data set is maintained wherever it was in either NVSRAM 320 or flash memory 335. In this case, flash memory 335 is not necessarily avoided. Allowing access into the flash memory is less of a problem as the degradation caused by reading a flash memory cell is less than that caused by a write to a flash memory cell.

As yet another example, where a write command is executed by processor 310, the data set indicated by the write command is written to NVSRAM 320 by read/write control circuit 352 without accessing flash memory 335. Only when NVSRAM 320 is full and the data set is selected as part of a block to be unloaded from NVSRAM 320 (or where applicable when a power down occurs) is the data set written to flash memory 335. The write to NVSRAM 320 may include a block transfer from NVSRAM 320 to flash memory 335 to make room for the newly written data. The block of data selected for transfer from NVSRAM 320 to flash memory 335 is selected based upon a replacement algorithm implemented by read/write control circuit 352. Further, the flash memory device 330 to which the block of transferred data will be written in flash memory 335 is selected by incremental device selector circuit 354. Utilizing NVSRAM 320 again limits the number of write accesses that are performed to flash memory 335 resulting in extended lifecycle of the flash memory devices.

In addition, any state of a memory controller governing operation of flash memory 335 may be maintained in NVSRAM 320. In particular, NVSRAM 320 may store all pertinent code and data through a power off sequence where NVSRAM 320 has an ability to maintain the stored data through a power down period. When power is reapplied to the memory system (i.e., the combination of NVSRAM 320 and flash memory 335) of computer system 200, the various startup codes and information can be accessed from NVSRAM 320 in a relatively short period of time. By doing this, startup time for the memory may be substantially reduced. As an example, it is common for the startup time of a flash memory based memory device to take between one half (0.5) and two (2.0) seconds. In contrast, accessing NVSRAM 320 is much faster resulting in a reduction of the period required to restart a system.

Turning to FIG. 4, a computer system 400 is shown that includes a processor 410 that is communicably coupled to a memory system having both an NVSRAM 420 and a flash memory 435 utilizing an interface circuit 450 having a read/write control circuit 452 and without wear leveling control in accordance with some embodiments of the present invention. NVSRAM 420 may be any NVSRAM known in the art, or may be replaced with another type of non-volatile memory. Flash memory 435 may be any type of flash memory known in the art including, but not limited to, single bit per cell flash memory, two bit per cell flash memory, three bit per cell flash memory, flash memory with a built in wear leveling circuitry, flash memory without any wear leveling circuitry, or the like. Flash memory 435 is composed of many individual flash memory devices 430. It should be noted that while flash memory 435 is shown as including four flash memory devices 430, that other numbers of flash memory devices may be used to comprise a flash memory in accordance with different embodiments of the present invention. Processor 410 may be any processor known in the art, and the connections between processor 410 and I/O interface circuit 450 may be either direct, or via another interface circuit. In some cases, NVSRAM 420 is smaller (i.e., holds less data) than flash memory 435. In one particular case, flash memory 435 is ten times larger than NVSRAM 420. Based upon the disclosure provided herein, one of ordinary skill in the art will recognize a variety of sizes for flash memory 435 and NVSRAM 420, and ratios between the sizes of flash memory 435 and NVSRAM 420.

In operation, any memory read request from processor 410 is directed by read/write control circuit 452 to be satisfied from NVSRAM 420 if possible, and from flash memory 435 if the read request cannot be satisfied from NVSRAM 420. Where a data set associated with the request is modified, read/write control circuit 452 directs writing of the modified data set to NVSRAM 420. Where NVSRAM 420 is full, read/write control circuit 452 causes a block transfer from NVSRAM 420 to flash memory 435 to make room for the newly modified data. The size of the block transfer may be the size of blocks expected by flash memory 435. The particular flash memory device 430 within flash memory 435 to which the block of transferred data will be written is any available block of flash memory 435. No wear leveling is implemented by I/O interface circuit 450, but rather the lifecycle of flash memory 435 is extended only by reducing the number of write accesses to flash memory 435. The block transfer from NVSRAM 420 to flash memory 435 includes data selected based upon a replacement scheme implemented by read/write control circuit 452. This replacement scheme may be, for example, a least recently used replacement scheme. Based upon the disclosure provided herein, one of ordinary skill in the art may recognize other replacement schemes that may be used. In some cases, where the table that tracks the logical location of data sets is accessed often, the replacement scheme maintains the table in NVSRAM 420. As such, substantial degradation to flash memory 435 may be limited even where no wear leveling algorithm is employed.

As a more particular example of operation, where a read/modify/write command is executed by processor 410, NVSRAM 420 is accessed under the control of read/write control circuit 452 to determine whether it holds the data set indicated by the read/write/modify command. Where the data set is available in NVSRAM 420, it is read without accessing flash memory 435. Once modified by processor 410, the data set is written back to NVSRAM 420 by read/write control circuit 452 without accessing flash memory 435. Only when NVSRAM 420 is full and the data set is selected as part of a block to be unloaded from NVSRAM 420 (or where applicable when a power down occurs) is the data set written back to flash memory 435. The block of data selected for transfer from NVSRAM 420 to flash memory 435 is selected based upon a replacement algorithm implemented by read/write control circuit 452. The physical location in flash memory 435 to which the block of transferred data will be written is selected as the next available block without regard for wear leveling. Alternatively, where the data set indicated by the read/write/modify command is not available in NVSRAM 420, flash memory 435 is accessed to obtain the data set. Once the modification is completed by processor 410, the data set is written back to NVSRAM 420. Again, this write back may include a block transfer from NVSRAM 420 to flash memory 435 under control of read/write control circuit 452 to make room for the newly modified data. Utilizing NVSRAM 420 limits the number of write accesses that are performed to flash memory 435 resulting in extended lifecycle of flash memory 435.

As another example, where a read command is executed by processor 410, NVSRAM 420 is accessed by read/write control circuit 452 to determine whether it holds the data set indicated by the read command. Where the data set is available in NVSRAM 420, it is read without accessing flash memory 435. Alternatively, where the data set indicated by the read command is not available in NVSRAM 420, flash memory 435 is accessed by read/write control circuit 452 to obtain the data set. Of note, the data set is maintained wherever it was in either NVSRAM 420 or flash memory 435. In this case, flash memory 435 is not necessarily avoided. Allowing access into the flash memory is less of a problem as the degradation caused by reading a flash memory cell is less than that caused by a write to a flash memory cell.

As yet another example, where a write command is executed by processor 410, the data set indicated by the write command is written to NVSRAM 420 by read/write control circuit 452 without accessing flash memory 435. Only when NVSRAM 420 is full and the data set is selected as part of a block to be unloaded from NVSRAM 420 (or where applicable when a power down occurs) is the data set written to flash memory 435. The write to NVSRAM 420 may include a block transfer from NVSRAM 420 to flash memory 435 to make room for the newly written data. The block of data selected for transfer from NVSRAM 420 to flash memory 435 is selected based upon a replacement algorithm implemented by read/write control circuit 452. Further, the physical location in flash memory 435 to which the block of transferred data will be written is selected as the next available block without regard for wear leveling. Utilizing NVSRAM 420 again limits the number of write accesses that are performed to flash memory 435 resulting in extended lifecycle of the flash memory devices.

In addition, any state of a memory controller governing operation of flash memory 435 may be maintained in NVSRAM 420. In particular, NVSRAM 420 may store all pertinent code and data through a power off sequence where NVSRAM 420 has an ability to maintain the stored data through a power down period. When power is reapplied to the memory system (i.e., the combination of NVSRAM 420 and flash memory 435) of computer system 200, the various startup codes and information can be accessed from NVSRAM 420 in a relatively short period of time. By doing this, startup time for the memory may be substantially reduced. As an example, it is common for the startup time of a flash memory based memory device to take between one half (0.5) and two (2.0) seconds. In contrast, accessing NVSRAM 420 is much faster resulting in a reduction of the period required to restart a system.

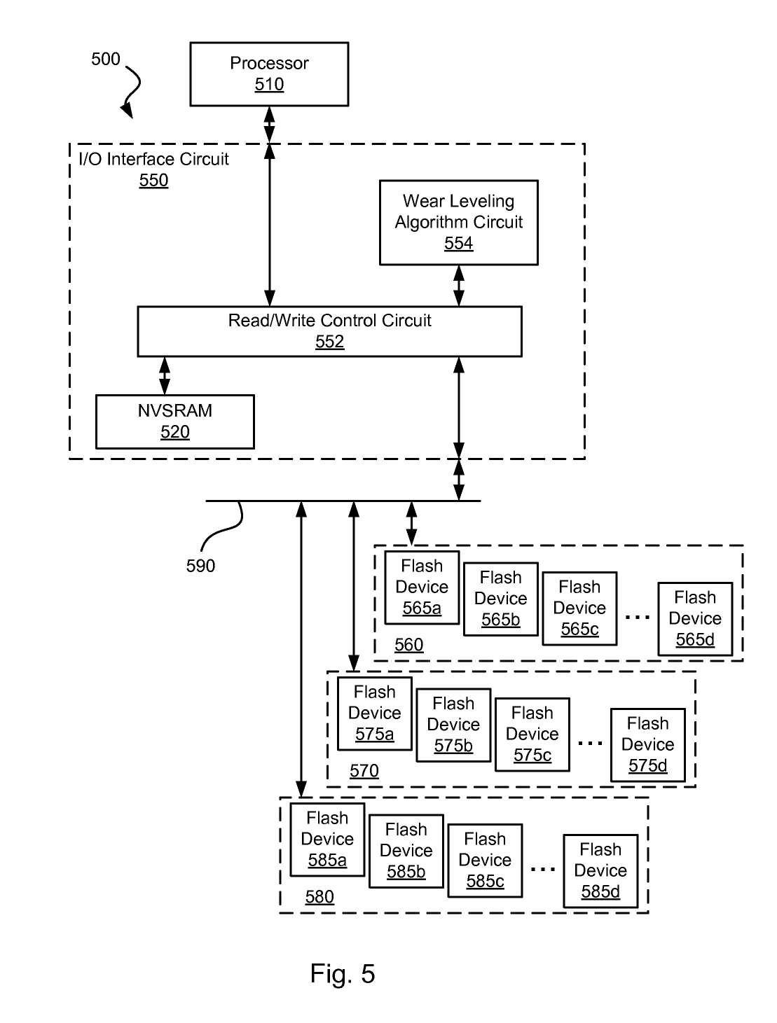

Turning to FIG. 5, a computer system 500 is shown that includes a processor 510 that is communicably coupled to a memory system having a number of flash memory units 560, 570, 580 via an I/O interface circuit 550. Flash memory units 560, 570, 580 are electrically coupled to I/O interface circuit 550 via a memory bus 590. Interface circuit 550 includes a read/write control circuit 552, a wear leveling algorithm circuit 554, and an NVSRAM 520. NVSRAM 520 may be any NVSRAM known in the art, or may be implemented with another type of non-volatile memory. Replaceable flash memory unit 560 includes a number of flash memory devices 565; replaceable flash memory unit 570 includes a number of flash memory devices 575; and replaceable flash memory unit 580 includes a number of flash memory devices 585. Flash memory devices 565, 575, 585 may be any type of flash memory known in the art including, but not limited to, single bit per cell flash memory, two bit per cell flash memory, three bit per cell flash memory, flash memory with a built in wear leveling circuitry, flash memory without any wear leveling circuitry, and/or the like. It should be noted that while each of replaceable flash memory units 560, 570, 580 are shown as including four flash memory devices, that other numbers of flash memory devices may be used to comprise a flash memory in accordance with different embodiments of the present invention. Processor 510 may be any processor known in the art, and the connections between processor 510 and I/O interface circuit 550 may be either direct, or via another interface circuit. In some cases, NVSRAM 520 is smaller (i.e., holds less data) than flash memory 535. In one particular case, flash memory 535 is ten times larger than NVSRAM 520. Based upon the disclosure provided herein, one of ordinary skill in the art will recognize a variety of sizes for flash memory 535 and NVSRAM 520, and ratios between the sizes of flash memory 535 and NVSRAM 520.

In operation, any memory read request from processor 510 is directed by read/write control circuit 552 to be satisfied from NVSRAM 520 if possible, and from one of flash memory units 560, 570, 580 if the read request cannot be satisfied from NVSRAM 520. Where a data set associated with the request is modified, read/write control circuit 552 directs writing of the modified data set to NVSRAM 520. Where NVSRAM 520 is full, read/write control circuit 552 causes a block transfer from NVSRAM 520 to one of flash memory units 560, 570, 580 to make room for the newly modified data. The size of the block transfer may be the size of blocks expected by flash memory units 560, 570, 580. The physical locations in flash memory to which the block of transferred data will be written are selected by wear leveling algorithm circuit 554. Wear leveling algorithm circuit 554 seeks to assure that degradation of each of the cells within flash memory remains approximately the same. As such, wear leveling algorithm circuit 554 may implement any flash memory wear leveling algorithm known in the art. The block transfer from NVSRAM 520 to one of flash memory units 560, 570, 580 includes data selected based upon a replacement scheme implemented by read/write control circuit 552. This replacement scheme may be, for example, a least recently used replacement scheme. Based upon the disclosure provided herein, one of ordinary skill in the art may recognize other replacement schemes that may be used. In some cases, where the table that tracks the logical location of data sets is accessed often, the replacement scheme maintains the table in NVSRAM 520. As such, substantial degradation to the flash memory may be limited.

As a more particular example of operation, where a read/modify/write command is executed by processor 510, NVSRAM 520 is accessed under the control of read/write control circuit 552 to determine whether it holds the data set indicated by the read/write/modify command. Where the data set is available in NVSRAM 520, it is read without accessing any of flash memory units 560, 570, 580. Once modified by processor 510, the data set is written back to NVSRAM 520 by read/write control circuit 552 without accessing the flash memory. Only when NVSRAM 520 is full and the data set is selected as part of a block to be unloaded from NVSRAM 520 (or where applicable when a power down occurs) is the data set written back to the flash memory. The block of data selected for transfer from NVSRAM 520 to the flash memory is selected based upon a replacement algorithm implemented by read/write control circuit 552. Further, the locations to which the block of transferred data will be written in on of flash memory units 560, 570, 580 are selected by wear leveling algorithm circuit 554. Alternatively, where the data set indicated by the read/write/modify command is not available in NVSRAM 520, one of flash memory units 560, 570, 580 is accessed to obtain the data set. Once the modification is completed by processor 510, the data set is written back to NVSRAM 520. Again, this write back may include a block transfer from NVSRAM 520 to the flash memory under control of read/write control circuit 552 to make room for the newly modified data. Utilizing NVSRAM 520 limits the number of write accesses that are performed to one of flash memory units 560, 570, 580 resulting in extended lifecycle of the flash memory.

As another example, where a read command is executed by processor 510, NVSRAM 520 is accessed by read/write control circuit 552 to determine whether it holds the data set indicated by the read command. Where the data set is available in NVSRAM 520, it is read without accessing any of flash memory units 560, 570, 580. Alternatively, where the data set indicated by the read command is not available in NVSRAM 520, the flash memory is accessed by read/write control circuit 552 to obtain the data set. Of note, the data set is maintained wherever it was in either NVSRAM 520 or one of flash memory units 560, 570, 580. In this case, the flash memory is not necessarily avoided. Allowing access into the flash memory is less of a problem as the degradation caused by reading a flash memory cell is less than that caused by a write to a flash memory cell.

As yet another example, where a write command is executed by processor 510, the data set indicated by the write command is written to NVSRAM 520 by read/write control circuit 552 without accessing any of flash memory units 560, 570, 580. Only when NVSRAM 520 is full and the data set is selected as part of a block to be unloaded from NVSRAM 520 (or where applicable when a power down occurs) is the data set written to the flash memory. The write to NVSRAM 520 may include a block transfer from NVSRAM 520 to one of flash memory units 560, 570, 580 to make room for the newly written data. The block of data selected for transfer from NVSRAM 520 to the flash memory is selected based upon a replacement algorithm implemented by read/write control circuit 552. Further, the locations to which the block of transferred data will be written in the flash memory are selected by wear leveling algorithm circuit 554. Utilizing NVSRAM 520 again limits the number of write accesses that are performed to flash memory units 560, 570, 580 resulting in extended lifecycle of the flash memory.

In addition, any state of a memory controller governing operation of the flash memory may be maintained in NVSRAM 520. In particular, NVSRAM 520 may store all pertinent code and data through a power off sequence where NVSRAM 520 has an ability to maintain the stored data through a power down period. When power is reapplied to the memory system (i.e., the combination of NVSRAM 520 and the flash memory) of computer system 500, the various startup codes and information can be accessed from NVSRAM 520 in a relatively short period of time. By doing this, startup time for the memory may be substantially reduced. As an example, it is common for the startup time of a flash memory based memory device to take between one half (0.5) and two (2.0) seconds. In contrast, accessing NVSRAM 520 is much faster resulting in a reduction of the period required to restart a system.

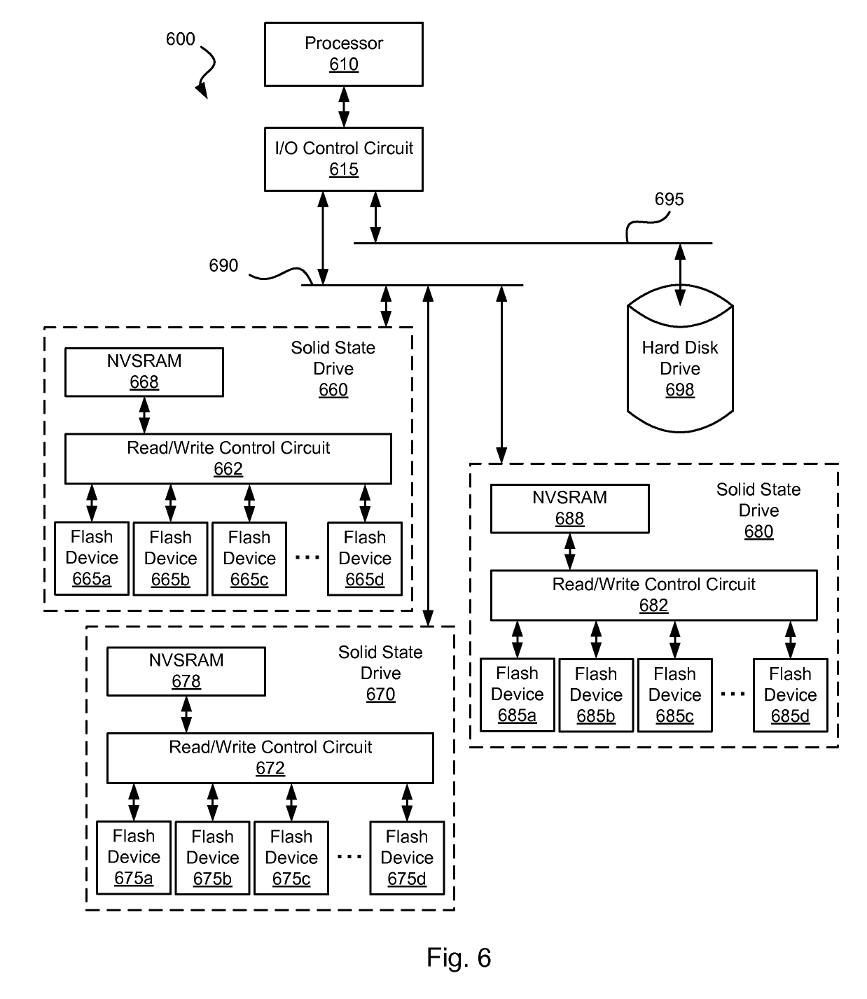

Turning to FIG. 6, a computer system 600 is shown that includes a processor 610 that is communicably coupled to a memory system via an I/O control circuit 615. The memory system includes a number of solid state drives 660, 670, 680 electrically coupled to I/O control circuit 615 via a memory bus 690. The memory system also includes a hard disk drive 698 electrically coupled to I/O control circuit 615 via a memory bus 695. I/O control circuit 615 provides an ability to transfer data between various forms of I/O and processor 610. Processor 610 may be any processor known in the art, and the connections between processor 610 and I/O control circuit 615 may be either direct, or via another interface circuit. Hard disk drive 698 may be any hard disk drive known in the art, or may be replaced by another form of non-volatile memory known in the art.

Solid state drive 660 includes an NVSRAM 668 and a number of flash memory devices 665. Access to flash memory devices 665 and NVSRAM 668 is governed by a read/write control circuit 662. Flash memory devices 665 may be any type of flash memory known in the art including, but not limited to, single bit per cell flash memory, two bit per cell flash memory, three bit per cell flash memory, flash memory with a built in wear leveling circuitry, flash memory without any wear leveling circuitry, and/or the like. It should be noted that while solid state drive 660 is shown as including four flash memory devices, that other numbers of flash memory devices may be used to implement a solid state drive in accordance with different embodiments of the present invention. NVSRAM 668 may be any NVSRAM known in the art, or may be implemented with another type of non-volatile memory. In some cases, NVSRAM 668 is smaller (i.e., holds less data) than the aggregate of flash memory devices 665. In one particular case, the aggregate of flash memory devices 665 is ten times larger than NVSRAM 668. Based upon the disclosure provided herein, one of ordinary skill in the art will recognize a variety of sizes for the aggregate of flash memory devices 665 and NVSRAM 668, and ratios between the sizes of the flash memory and NVSRAM 668.

Solid state drive 670 includes an NVSRAM 678 and a number of flash memory devices 675. Access to flash memory devices 675 and NVSRAM 678 is governed by a read/write control circuit 672. Flash memory devices 675 may be any type of flash memory known in the art including, but not limited to, single bit per cell flash memory, two bit per cell flash memory, three bit per cell flash memory, flash memory with a built in wear leveling circuitry, flash memory without any wear leveling circuitry, and/or the like. It should be noted that while solid state drive 670 is shown as including four flash memory devices, that other numbers of flash memory devices may be used to implement a solid state drive in accordance with different embodiments of the present invention. NVSRAM 678 may be any NVSRAM known in the art, or may be implemented with another type of non-volatile memory. In some cases, NVSRAM 678 is smaller (i.e., holds less data) than the aggregate of flash memory devices 675. In one particular case, the aggregate of flash memory devices 675 is ten times larger than NVSRAM 678. Based upon the disclosure provided herein, one of ordinary skill in the art will recognize a variety of sizes for the aggregate of flash memory devices 675 and NVSRAM 678, and ratios between the sizes of the flash memory and NVSRAM 678.

Solid state drive 680 includes an NVSRAM 688 and a number of flash memory devices 685. Access to flash memory devices 685 and NVSRAM 688 is governed by a read/write control circuit 682. Flash memory devices 685 may be any type of flash memory known in the art including, but not limited to, single bit per cell flash memory, two bit per cell flash memory, three bit per cell flash memory, flash memory with a built in wear leveling circuitry, flash memory without any wear leveling circuitry, and/or the like. It should be noted that while solid state drive 680 is shown as including four flash memory devices, that other numbers of flash memory devices may be used to implement a solid state drive in accordance with different embodiments of the present invention. NVSRAM 688 may be any NVSRAM known in the art, or may be implemented with another type of non-volatile memory. In some cases, NVSRAM 688 is smaller (i.e., holds less data) than the aggregate of flash memory devices 685. In one particular case, the aggregate of flash memory devices 665 is ten times larger than NVSRAM 688. Based upon the disclosure provided herein, one of ordinary skill in the art will recognize a variety of sizes for the aggregate of flash memory devices 685 and NVSRAM 688, and ratios between the sizes of the flash memory and NVSRAM 688.

In operation, any memory read request from processor 610 is directed by I/O control circuit 615 to the one of hard disk drive 698, solid state drive 660, solid state drive 670 or solid state drive 680 where the data set associated with the memory read request. Where, for example, the data set is identified by I/O control circuit 615 to be maintained on solid state drive 660, I/O control circuit directs the read request to solid state drive 660. Read/write control circuit 662 attempts to satisfy the read request from NVSRAM 668. Where the requested data set is not available from NVSRAM 668, it is accessed from one or more of flash memory devices 665. Where the data set associated with the request is modified and written back to memory by processor 610, read/write control circuit 662 directs writing of the modified data set to NVSRAM 668. Where NVSRAM 668 is full, read/write control circuit 662 causes a block transfer from NVSRAM 668 to one of flash memory devices 665 to make room for the newly modified data. The size of the block transfer may be the size of blocks expected by flash memory devices 665. The physical locations in flash memory devices 665 to which the block of transferred data will be written may be selected as the next available locations. While not shown, other embodiments of the present invention may include some type of wear leveling circuitry such as that discussed above in relation to FIG. 2 and FIG. 3 above. Such wear leveling circuitry governs the locations to which the block transfer into flash memory devices 665 is directed. The block transfer from NVSRAM 668 to one or more of flash memory devices 665 includes data selected based upon a replacement scheme implemented by read/write control circuit 662. This replacement scheme may be, for example, a least recently used replacement scheme. Based upon the disclosure provided herein, one of ordinary skill in the art may recognize other replacement schemes that may be used. In some cases, where the table that tracks the logical location of data sets is accessed often, the replacement scheme maintains the table in NVSRAM 668. As such, substantial degradation to the flash memory may be limited.

As a more particular example of operation, where a read/modify/write command is executed by processor 610 on data accessed from solid state drive 660, NVSRAM 668 is accessed under the control of read/write control circuit 662 to determine whether it holds the data set indicated by the read/write/modify command. Where the data set is available in NVSRAM 668, it is read without accessing any of flash memory devices 665. Once modified by processor 610, the data set is written back to NVSRAM 668 by read/write control circuit 662 without accessing the flash memory. Only when NVSRAM 668 is full and the data set is selected as part of a block to be unloaded from NVSRAM 668 (or where applicable when a power down occurs) is the data set written back to the flash memory. The block of data selected for transfer from NVSRAM 668 to the flash memory is selected based upon a replacement algorithm implemented by read/write control circuit 662. The physical locations in flash memory devices 665 to which the block of transferred data will be written may be selected as the next available locations. While not shown, other embodiments of the present invention may include some type of wear leveling circuitry such as that discussed above in relation to FIG. 2 and FIG. 3 above. Such wear leveling circuitry governs the locations to which the block transfer into flash memory devices 665 is directed.

Alternatively, where the data set indicated by the read/write/modify command is not available in NVSRAM 668, one of flash memory devices 665 is accessed to obtain the data set. Once the modification is completed by processor 610, the data set is written back to NVSRAM 668. Again, this write back may include a block transfer from NVSRAM 668 to the flash memory under control of read/write control circuit 662 to make room for the newly modified data. Utilizing NVSRAM 668 limits the number of write accesses that are performed to one of flash memory devices 665 resulting in extended lifecycle of the flash memory.

As another example, where a read command is executed by processor 610 requesting data maintained on solid state drive 660, NVSRAM 668 is accessed by read/write control circuit 662 to determine whether it holds the data set indicated by the read command. Where the data set is available in NVSRAM 668, it is read without accessing any of flash memory devices 665. Alternatively, where the data set indicated by the read command is not available in NVSRAM 668, the flash memory is accessed by read/write control circuit 662 to obtain the data set. Of note, the data set is maintained wherever it was in either NVSRAM 668 or one of flash memory devices 665. In this case, the flash memory is not necessarily avoided. Allowing access into the flash memory is less of a problem as the degradation caused by reading a flash memory cell is less than that caused by a write to a flash memory cell.

As yet another example, where a write command is executed by processor 610 to write data to solid state drive 660, the data set indicated by the write command is written to NVSRAM 668 by read/write control circuit 662 without accessing any of flash memory devices 665. Only when NVSRAM 668 is full and the data set is selected as part of a block to be unloaded from NVSRAM 668 (or where applicable when a power down occurs) is the data set written to the flash memory. The write to NVSRAM 668 may include a block transfer from NVSRAM 668 to one of flash memory devices 665 to make room for the newly written data. The block of data selected for transfer from NVSRAM 668 to the flash memory is selected based upon a replacement algorithm implemented by read/write control circuit 662. The physical locations in flash memory devices 665 to which the block of transferred data will be written may be selected as the next available locations. While not shown, other embodiments of the present invention may include some type of wear leveling circuitry such as that discussed above in relation to FIG. 2 and FIG. 3 above. Such wear leveling circuitry governs the locations to which the block transfer into flash memory devices 665 is directed. Utilizing NVSRAM 668 again limits the number of write accesses that are performed to flash memory units 665 resulting in extended lifecycle of the flash memory.

Of note, accesses to solid state drives 670, 680 is substantially the same as that described above in relation to the description of accesses to solid state drive 660. Additionally, wear leveling circuitry may be included as part of IO/control circuit 615 that is used to direct data accesses across all of solid state drives 660, 670, 680 as if the solid state drives are treated as one memory. In some cases, one of solid state drives 660, 670, 680 may provide an indication to processor 610 that it is nearing the end of its lifecycle. In such a situation, processor 610 may direct transfer of data from the failing solid state drive to hard disk drive 698. This allows for replacement of the failing solid state drive, at which time the data previously transferred to hard disk drive 698 may be moved back to the replacement solid state drive. It should be noted that the flash devices in the solid state drives may be implemented as replaceable flash memory units similar to that discussed above in relation to FIG. 5.

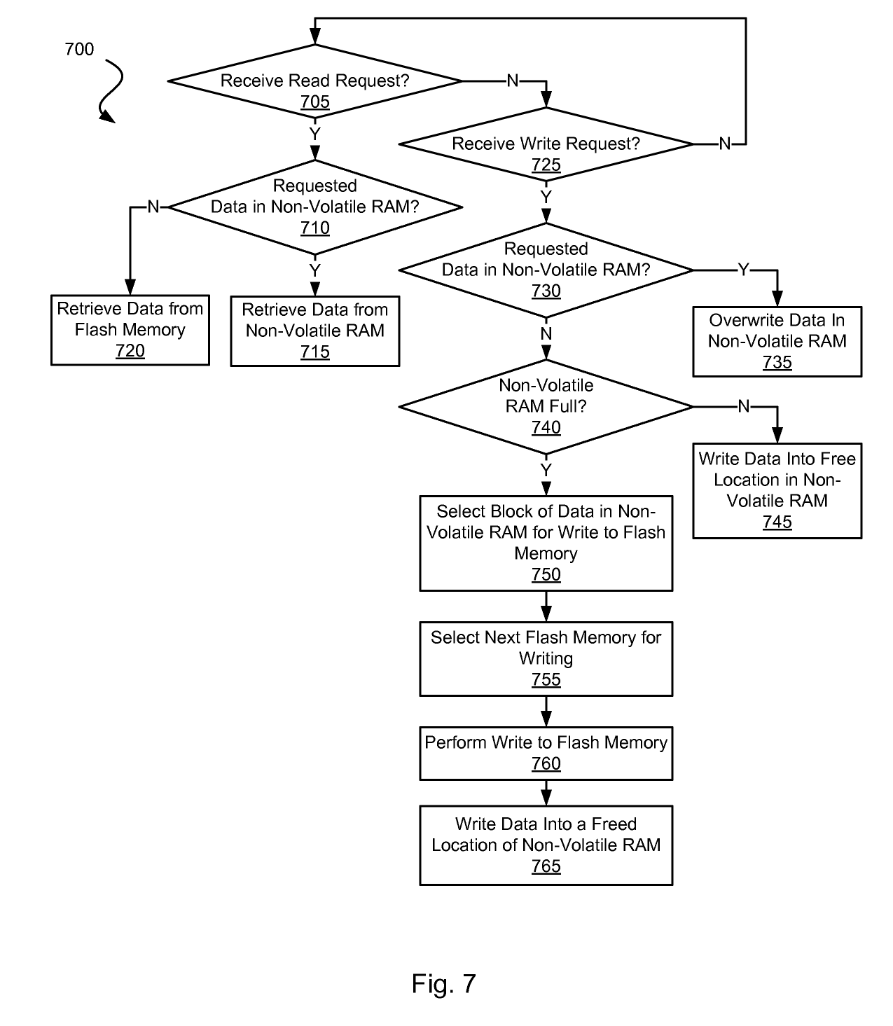

Turning to FIG. 7, a flow diagram 700 shows a method in accordance with various embodiments of the present invention for utilizing a combination memory system including both non-volatile RAM and flash memory. Following flow diagram 700, it is determined whether a read request has been received (block 705). Such a read request may be received from a processor executing software commands either directly or via an intervening hardware I/O circuit. As an example, such a read request may indicate a location of a data set and the size of the data set to be read. Where a read request is received (block 705), it is determined whether the data set indicated by the read request is available from a non-volatile RAM operating in relation to a bank of flash memory (block 710). Where the data set is available from the non-volatile RAM (block 710), the data set is retrieved from the non-volatile RAM and passed back to the requestor (block 715). Alternatively, where the data set is not available from the non-volatile RAM (block 710), the data set is retrieved from the flash memory bank and passed back to the requestor (block 720).

Alternatively, it is determined whether a write request has been received (block 725). Where a write request has been received (block 725), it is determined whether the data set associated with the write request was previously stored in a non-volatile RAM operating in relation to a bank of flash memory (block 730). Where the data set was previously stored in the non-volatile RAM (block 735), the corresponding data set currently in the non-volatile RAM is overwritten and the process completes (block 735).

Alternatively, where the corresponding data set is not available in the non-volatile RAM (block 730), it is determined whether the non-volatile RAM is full (block 740). Where the non-volatile RAM is not full (block 740), the data set associated with the write request is written into a free location in the non-volatile RAM and the process completes (block 745). Where, in contrast, the non-volatile RAM is full (block 740), a block of data in the non-volatile RAM is selected for transfer to the flash memory (block 750). This block of data may be of a block utilized by the flash memory and may be selected based on a replacement algorithm. In addition, the next flash memory device to be written is selected to receive the transferring block of data (block 755). The next flash memory device to be written may be selected using a wear leveling algorithm, or may be selected using a simple round robin routine. Once the location in the flash memory into which the data is to be written has been selected (block 755), the data block is copied from the non-volatile RAM to the selected location in the flash memory (block 760). The data set associated with the original write request is then written into the freed location of the non-volatile memory and the process completes (block 765).

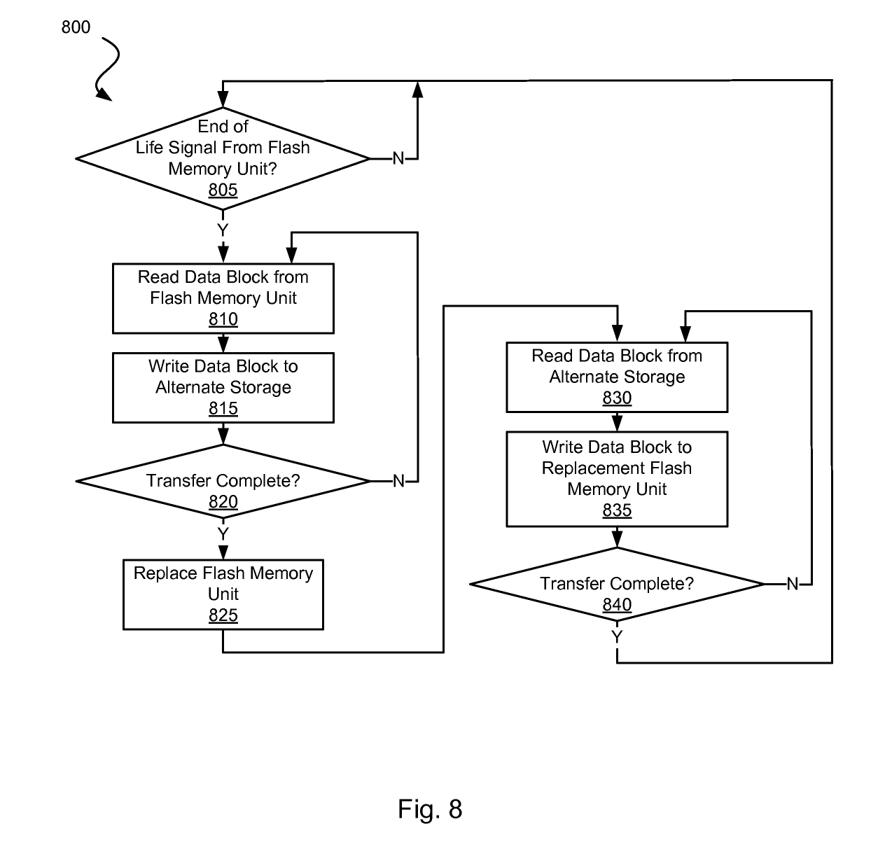

Turning to FIG. 8, a flow diagram 800 shows a method in accordance with some embodiments of the present invention for replacing flash memory units. Following flow diagram 800, it is determined whether an end of life signal has been received from a replaceable flash memory unit (block 805). Such an end of life signal indicates that usable memory cells within the replaceable flash memory unit have degraded to the extent that they are becoming unreliable. Where an end of life signal is received (block 805), a data block is read from the failing flash memory unit (block 810). The size of the retrieved data block may be the size supported by the flash memory unit. The block read from the flash memory is then written to an alternative storage medium (block 815). The alternative storage medium may be, for example, a hard disk drive or another flash memory unit. It is then determined whether all of the data has been moved from the failing flash memory unit to the alternative storage (block 820). Where the transfer is not complete (block 820), the processes of blocks 810 to 820 are repeated for the next block. Alternatively, where the transfer is complete (block 820), the failing flash memory unit may be replaced (block 825). The data moved to the alternative storage may then be read from the alternative storage (block 830) and transferred to the replacement flash memory unit (block 835). This process of transferring data is continued until all of the data has been moved from the alternative storage to the replacement flash memory unit (block 840).

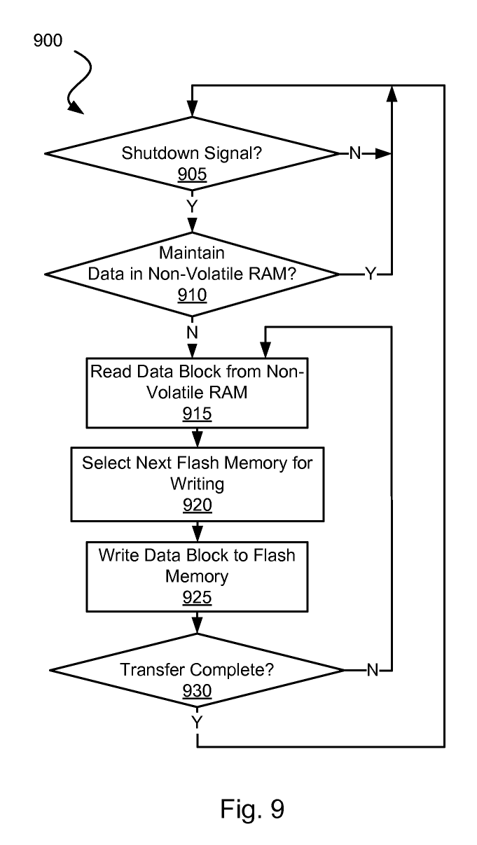

Turning to FIG. 9, a flow diagram 900 shows a method in accordance with some embodiments of the present invention for performing a memory system shutdown. Following flow diagram 900, it is determined whether a shutdown signal has been received (block 905). Such a shutdown signal indicates that information stored in a non-volatile memory associated with a flash memory is about to be lost. This may happen, for example, where the non-volatile memory is a battery backed static RAM and the available power from the battery is reaching a critical threshold. Based upon the disclosure provided herein, one of ordinary skill in the art will recognize a variety of scenarios when a shutdown signal is asserted. Where a shutdown signal is received (block 910), it is determined whether information maintained in the non-volatile memory is to be saved (block 910). Where the data in the non-volatile memory is not to be saved (block 910), the process ends. In such a case, when power is restored, the memory system will operate as if there is nothing in the non-volatile memory and that the most up to date information is in the associated flash memory.

Alternatively, where the data in the non-volatile memory is to be saved (block 910), a data block is read from the non-volatile memory (block 915). The size of the retrieved data block may be the size supported by the flash memory. In addition, the next flash memory area to be written is selected to receive the transferring data block (block 920). The next flash memory device to be written may be selected using a wear leveling algorithm, or may be selected using a simple round robin routine. Once the location in the flash memory into which the data is to be written has been selected (block 920), the data block is copied from the non-volatile memory to the selected location in the flash memory (block 925). It is then determined whether all of the data has been moved from the non-volatile memory to the flash memory (block 930). Where the transfer is not complete (block 930), the processes of blocks 915 to 930 are repeated for the next block. Alternatively, where the transfer is complete (block 930), the process completes preserving the data from the non-volatile memory in the flash memory.

In conclusion, the invention provides novel systems, devices, methods and arrangements for flash memory based computer systems and memory devices. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A memory system, the memory system comprising:
a non-volatile memory;
a flash memory; and
a read/write controller circuit, wherein the read/write controller circuit is coupled to both the flash memory and the non-volatile memory, and wherein the read/write controller circuit is operable to receive a data set directed to the flash memory and to direct the data set to the non-volatile memory.

2. The memory system of claim 1, wherein directing the data set to the non-volatile memory extends a lifecycle of the flash memory.

3. The memory system of claim 1, wherein the read/write controller circuit is further operable to direct a read request for the data set to the non-volatile memory.

4. The memory system of claim 3, wherein the read/write controller circuit is further operable to transfer a data block from the non-volatile memory to the flash memory to make room for the data set in the non-volatile memory.

5. The memory system of claim 4, wherein the data block is selected by the read/write controller circuit using a replacement algorithm.

6. The memory system of claim 5, wherein the replacement algorithm is a least recently used algorithm.

7. The memory system of claim 4, wherein the memory system further comprises:
a wear leveling circuit, wherein the wear leveling circuit is operable to select a location in the flash memory to receive the data block.

8. The memory system of claim 7, wherein the wear leveling circuit implements a wear leveling algorithm that seeks to evenly spread writes across cells of the flash memory.

9. The memory system of claim 1, wherein the read/write controller circuit and the non-volatile memory are implemented on the same chip.

10. The memory system of claim 1, wherein the read/write controller circuit, the non-volatile memory, and the flash memory are combined into a replaceable memory subsystem.

11. The memory system of claim 10, wherein the replaceable memory subsystem is a solid state disk drive.

12. The memory system of claim 1, wherein the flash memory is implemented on a replaceable flash memory unit apart from the read/write controller circuit and the non-volatile memory.

13. The memory system of claim 1, wherein directing the data set to the non-volatile memory reduces a number of writes to the flash memory.

14. A method for data storage, the method comprising:
providing a memory system having a non-volatile memory and a flash memory;
receiving a first data set;
writing the first data set to the non-volatile memory;
receiving a second data set;
transferring the first data set to the flash memory; and
writing the second data set to the non-volatile memory.

15. The method of claim 14, wherein the method further comprises:
receiving a read request for the second data set; and
accessing the second data set from the non-volatile memory.

16. The method of claim 14, wherein the method further comprises:
receiving a read request for the first data set; and
accessing the first data set from the flash memory.

17. The method of claim 14, wherein the method further comprises:
applying a replacement algorithm to data in the non-volatile memory, wherein the first data set is selected to be transferred to the flash memory based at least in part on application of the replacement algorithm.

18. The method of claim 14, wherein the method further comprises:
applying a wear leveling algorithm to determine a location in the flash memory to which the first data set is written.

19. The method of claim 18, wherein the wear leveling algorithm operates evenly spread writes across cells of the flash memory.

20. A computer system, the computer system comprising:
a processor;
a memory system accessible by the processor, wherein the memory system includes:
a non-volatile memory;
a flash memory; and
a read/write controller circuit, wherein the read/write controller circuit is coupled to both the flash memory and the random access memory, and wherein the read/write controller circuit is operable to receive a data set directed to the flash memory and to direct the data set to the random access memory such that a lifecycle of the flash memory is extended.
